(19) United States
(12) Patent Application Publication
(10) Pub. No.: US 2018/0084484 A1
(43) Pub. Date: Mar. 22, 2018

(54) Bluetooth Connection Establishment

(71) Applicant: Apple Inc., Cupertino, CA (US)

(72) Inventor: Sriram HARIHARAN, Cupertino, CA (US)

(73) Assignee: Apple Inc., Cupertino, CA (US)

(21) Appl. No.: 15/270,482

(22) Filed: Sep. 20, 2016

(51) Int. Cl. H04W 48/08; H04L 12/24; H04W 4/00; H04W 76/02

(52) U.S. Cl. CPC H04W 48/08; H04L 41/0886; H04W 84/18; H04W 76/02; H04W 4/008

(57) ABSTRACT

Embodiments of the current disclosure facilitate the creation of a connection between a host device and an accessory device over a wireless network. For instance, according to some embodiments, a method of connecting an accessory device to a host device includes transmitting a plurality of advertising beacons over a wireless network. Each wireless beacon can contain information identifying a predetermined time when the accessory device will begin a page scan window. The accessory device can begin the page scan window at the predetermined time, and can then receive pages from a host device during the page scan window over the wireless network. The received page packets can then be subsequently used to establish an ad hoc network connection between the accessory device and the host device.

### BACKGROUND OF THE INVENTION

Ad hoc wireless networks including a host and one or more accessory devices have become much more common in recent years. Such a network might include, for instance, a wireless device such as a smart phone and an accessory such as, for example, a set of wireless headphones connected to the smart phone through which telephone calls and/or music can be streamed. Such wireless ad hoc networks (e.g., Bluetooth networks) provide convenient and reliable connections between various devices. However, they can also be the cause of frustration to a user—for instance, there are often delays with establishing the network, which can negatively impact a user's experience with the network.

### BRIEF SUMMARY OF THE INVENTION

Embodiments of the current disclosure facilitate the creation of a connection between a host device and an accessory device over a wireless medium. For instance, according to some embodiments, a method of connecting one or more accessory devices to a host device is provided. The method includes wirelessly transmitting a plurality of advertising beacons. In some embodiments, a wireless beacon may contain information identifying a predetermined time when the accessory device will begin a page scan window. The accessory device may begin the page scan window at the predetermined time, and may then receive pages from a host device during the page scan window over the wireless network. The received page packets may then be subsequently used to establish an ad hoc network connection between the accessory device and the host device.

In some embodiments, one or more of the advertising beacons may include information identifying any/all of a duration of the page scan window, a value of the clock for the accessory at the beginning of the page scan window, and/or information identifying a channel to be used during the page scan window. Furthermore, the information identifying the predetermined time may include a temporal offset from the time that the advertising beacon is transmitted to the beginning of the page scan window. In some embodiments, the beacons may include Bluetooth low energy beacons that are transmitted at regular intervals. Furthermore, each of the advertising beacons may contain dynamically updated information. In some embodiments, the transmittal of the beacons and the beginning of the page scan may involve a set of operations that cannot be interrupted and that must be completed before another operation can begin.

Some embodiments may include devices and methods for establishing a connection between an accessory device and a host device over a wireless network. The method may include receiving an advertising beacon containing information that identifies a time when the accessory device will begin a page scan window. The device may then initiate paging during the time the advertising beacon indicated that the accessory will begin the page scan window. The device may then connect with the accessory device over the wireless network. According to some embodiments, the device may also determine whether the accessory device is proximate to the device, e.g., based on the received advertising beacon.

In some embodiments, the information identifying the time when the accessory device will begin a page scan may include a temporal offset until the page scan window will begin. Furthermore, the advertising beacon may include information identifying any/all of a duration of the page scan window, a value of a clock for the accessory device at the beginning of the page scan window, and/or information identifying a channel that will be used during the page scan beacon. The page scan beacon may include, in some embodiments, a Bluetooth low energy beacon. The method may further include receiving a second beacon that also contains information identifying the time when the accessory device will begin the page scan window. Furthermore, the information in the second beacon may be different from the information contained in the advertising beacon, but still identify the same time when the accessory device will begin the page scan window.

Other embodiments include devices and methods of initiating a connection between a host device and an accessory device. According to these embodiments, the host device may determine that an accessory device is proximate to the host device. The host device can then transmit a connection request to the accessory device. The connection request can include, among other things, information identifying a value of the host clock. The host device can then receive an acknowledgement from the accessory device. A connection between the accessory device and the host device can then be made, e.g., in order to create an ad hoc wireless network.

In some embodiments the host may determine that the accessory device is proximate to the host device by detecting one or more wireless beacons that are transmitted by the accessory device. The one or more wireless beacons may include Bluetooth low energy beacons in some instances.

In some embodiments, devices for and methods of initiating a wireless connection between an accessory device and a host device are provided. According to these embodiments, one or more advertising beacons may be transmitted by an accessory device. The accessory device may then receive a connection request from the host device. The connection request may include information identifying the value of a host device clock. The local clock of the accessory device may be synchronized with the clock of the host device, and a connection with the host device may be initiated using the synchronized local clock.

### BRIEF DESCRIPTION OF THE DRAWINGS/FIGURES

Embodiments of the present disclosure will now be described, by way of example only, with reference to the accompanying drawings in which corresponding reference symbols indicate corresponding parts. Further, the accompanying drawings, which are incorporated herein, form part of the specification and illustrate embodiments of the present disclosure.

FIG. 1 is a functional block diagram depicting an example of a host device with a plurality of accessory devices, according to some embodiments.

FIG. 2 is a diagram depicting example signals transmitted by a primary (master) device and a secondary (slave) device according to some embodiments.

FIG. 3 is a diagram depicting example signals transmitted by an accessory device according to some embodiments.

FIG. 4 is a sequence diagram depicting an example of the initiation of a communication between an accessory device and a host device according to some embodiments.

FIG. 5 is a flowchart depicting an example method of establishing communication between a host device and an accessory device according to some embodiments.

FIG. 6 is a flowchart depicting an example method of establishing communication between a host device and an accessory device according to some embodiments.

FIG. 7 depicts example signals transmitted by an accessory device and a host device according to some embodiments.

FIG. 8 is a flowchart depicting an example method of establishing communication between a host device and an accessory device according to some embodiments.

FIG. 9 is a flowchart depicting an example method of establishing communication between a host device and an accessory device according to some embodiments.

The features and advantages of embodiments of the present disclosure will become more apparent from the detailed description set forth below when taken in conjunction with the drawings. In the drawings, like reference numbers generally indicate identical, functionally similar, and/or structurally similar elements.

### DETAILED DESCRIPTION OF THE INVENTION

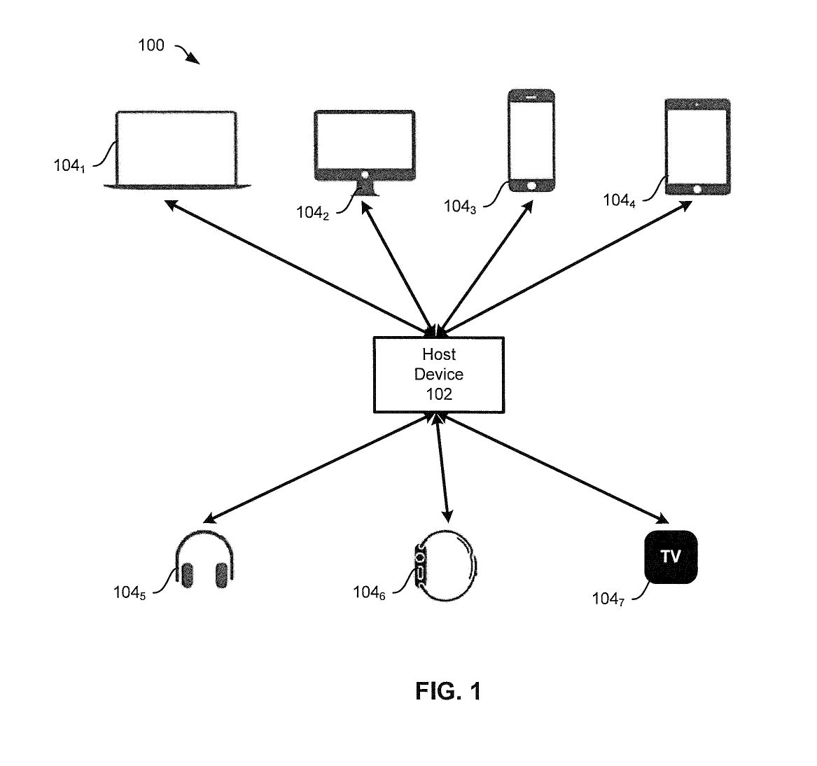

FIG. 1 is a functional block diagram depicting an example ad hoc network 100 according to some embodiments. The ad hoc network may include an accessory device 102 connected to one or more of host devices, e.g., accessory devices 104₁-104₇ via a connection such as via a wireless network connection. The host devices 104₁-104₇ (each generically referred to herein as “host device 104”) may include a wide assortment of different devices. For instance, the host devices 104 may include and/all of laptop computers, desktop computers, smart phones, tablet computers, wearable devices (such as an Apple Watch™), human interface devices, speaker devices, headphone devices, multimedia devices (such as an Apple TV™), etc.

The accessory device 102 may be any appropriate computing device, including any of a wireless headset, keyboard, mouse, computer, tablet, smart phone, media computer, or the like. Indeed, in some embodiments any/all of the accessory devices may be capable of functioning as a host device for the ad hoc network 100. In practice, the ad hoc network 100 depicted in FIG. 1 may operate to connect the accessory device 102 to one or more of the host devices. In some embodiments, this can occur by the accessory device 102 transmitting a plurality of advertising beacons over the wireless medium—which can then be received by one or more of the host devices 104. At least one of the advertising beacons may include at least information identifying a time at which the accessory device 102 will initiate a page scan window. The accessory device 102 can then initiate the page scan at the identified time, and receive one or more pages from one or more host devices 104 during the page scan. The connection between the host device 104 and the accessory device 102 can then be established in response to the received page.

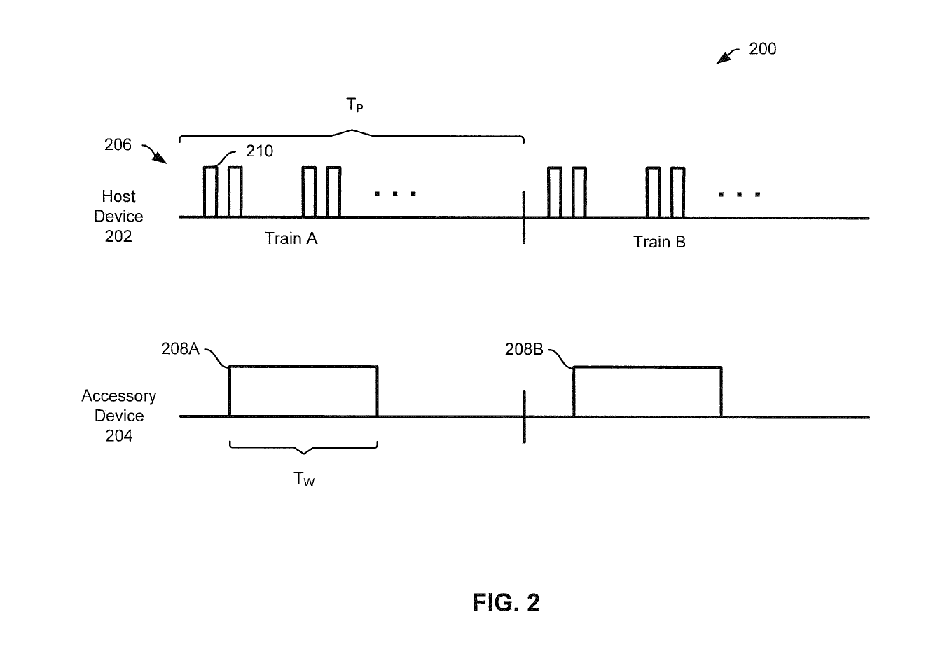

FIG. 2 is a depiction 200 of exemplary signals transmitted by a host device 202 and an accessory device 204, shown plotted against a time axis according to some embodiments of the disclosure, e.g., when the devices 202, 204 are attempting to establish a communication connection. As shown in FIG. 2, host device 202 may transmit a series of trains 206 including pages 210. FIG. 2 depicts the transmitted trains 206 using two trains: Train A and Train B, but more or fewer trains could be used in accordance with the scope and spirit of this disclosure. In some embodiments, the two trains may include Bluetooth paging and page scan operations. Each of the trains has a particular duration. For instance, train A, as shown in in the example of FIG. 2, has a duration of T_{P}. The respective durations of trains, e.g., Train A and Train B can be the same or can differ. Furthermore, in some embodiments, the trains, e.g., Train A and Train B, may be transmitted on the same channel or on different channels.

Accessory device 204 may periodically open page scan windows 208. For instance, page scan window 208A roughly corresponds to train A transmitted by the host device 202. Similarly, page scan window 208B roughly corresponds to train B transmitted by the host device 202. Each of the page scan windows may also have a corresponding duration (or period)—for instance, page scan window 208A is shown in FIG. 2 as having a duration T_{W}. It should be noted, that FIG. 2 is merely for illustrative purposes and no attempt has been made to depict the windows of the accessory device 204 and the transmissions of the host device 202 or the windows of the accessory device 204 to either a relative or absolute scale.

To connect, the accessory device 204 must detect, during a page scan window 208, one or more of the beacons 210 associated with one of the trains of beacons 206 transmitted by the host device 202. Once the accessory 204 detects a beacon 210 transmitted by the host device 202, the procedure for establishing a baseband connection can be followed and the devices 202 and 204 form a connection connected.

Since page scanning can consume significant amount of power, there is a desire among device manufacturers to reduce the size of the page scan windows 208. For example, using shorter page scan windows can reduce battery usage or power consumption. However, a problem can arise when the page scan window is too small: namely, the page scan window 208 may not align pages transmitted by the host device 202. Consequently, it may take several page scan windows 208 in order for the accessory device 204 to detect one or more pages 210 transmitted by the host device 202. This can delay establishment of the wireless connection between host devices 202 and accessory devices 204.

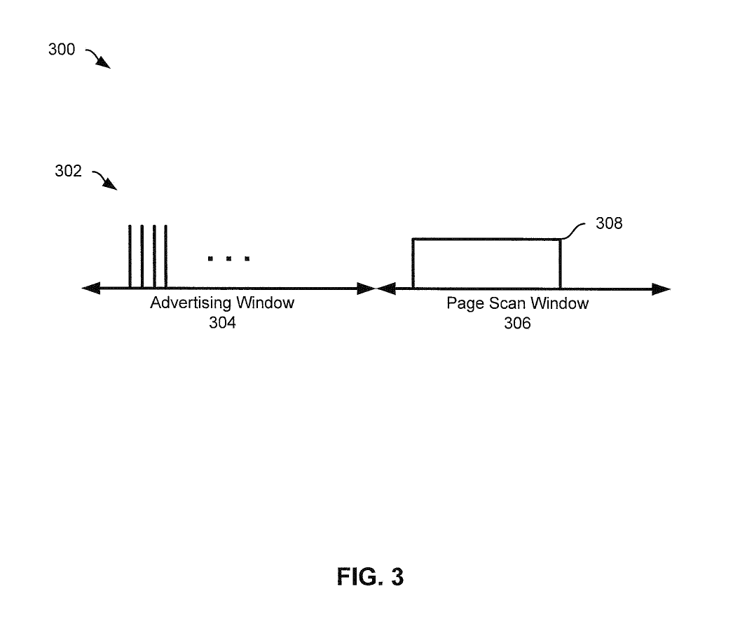

However, if the accessory device 204 could indicate to the host device 202 when it intends to begin its page scan window 208, a connection can be established more quickly and with reduced power consumption. This example arrangement is described in more detail with respect to FIG. 3.

FIG. 3 is a signaling diagram 300 depicting signals transmitted by a device, e.g., an accessory device 104, versus time, according to some embodiments. The diagram 300 shown in FIG. 3 depicts the signals functionally and no attempt has been made to show the signals to either an absolute or relative scale As shown in FIG. 3, the accessory device transmits a number of beacons 302 during an advertising window 304 and then performs a page scan 308 during a page scan window 306.

To expedite the connection between the accessory device and a host device, e.g., a host device 102, the accessory device may transmit, as part of the beacons 302, information pertaining to the page scan 308 it intends to perform. For instance, one or more of the beacons 302 may contain information that informs a device (e.g., a host device 102) that receives the beacons 302 when the accessory device will begin its page scan 308. This information may take the form of a temporal offset from the time when each individual beacon 302 is sent. For instance, if the accessory device intends to begin its page scan 308 at t=10, then a beacon 302 sent at t=0 could indicate a temporal offset of 10 and a beacon 302 sent at t=1 could indicated a temporal offset of 9, and so on. Accordingly, the information contained in each of the beacons 302 may be dynamically altered and different relative to each other. Alternately, the information in beacons 302 can indicate an absolute time when page scan 308 is to begin (i.e., at t=10 in the example). In some embodiments the beacons 302 may be implemented as beacons that comply with the Bluetooth low energy (LE) standard for beacons.

When a host device receives one of the beacons 302 sent by the accessory device, it can schedule its paging to begin during the scheduled page scan 308. In this way, it can be assured the accessory device will receive pages from the host device during the first page scan 308, while limiting the number of beacons 302 it needs to send to establish communication with the accessory device.

In addition to information informing the host device about the time the page scan 308 will begin, beacons 302 may include information identifying a duration of the page scan window, a value of a clock for the accessory at the time when the beacon was sent, a value of a clock for the accessory at the beginning of the page scan window, and/or information identifying a channel to be used during the page scan window. Indeed, in some embodiments, some or all of this information may be provided instead of the information regarding when the page scan will begin. According to some embodiments, a portion of the page scan window 306 may overlap with a portion of the advertising window 304 such that page scan window 306 at least partially overlaps in time with one or more of the advertising beacons 302. Additionally, according to some embodiments, the advertising window 304 and the page scan window 306 may be uninterruptable such that they must be completed (or fail) prior to any subsequent operation beginning.

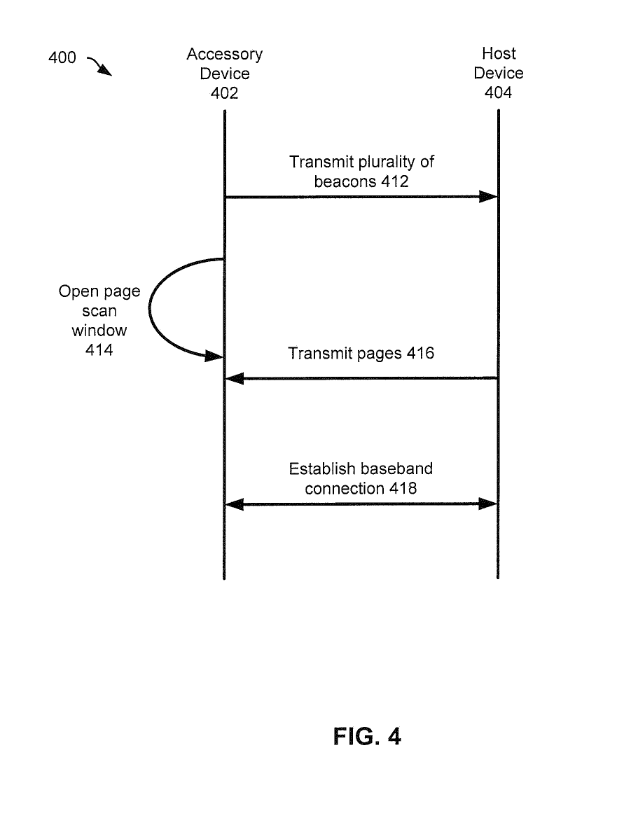

FIG. 4 is a sequence chart 400 depicting example signals transmitted between an accessory device 402 and a host device 404 according to some embodiments. As shown in FIG. 4, the accessory device 402 may first transmit a plurality of beacons 412, one or more of which may be wirelessly received by a host device 404. The beacons 412 may include information pertaining to a page scan (e.g., page scan 308) that it will perform at some point in the future. For instance, the beacons may contain information identifying the time when the accessory device will begin a page scan, which may be represented as a temporal offset from the time at which the page scan window will begin. In addition or alternately, the advertising beacon may include information identifying a duration of the page scan window, a value of a clock for the accessory device at the beginning of the page scan window, and/or information identifying a channel that will be used during the page scan beacon.

After transmitting the plurality of beacons 412 (for instance, after the end of advertising window 304), the accessory device 402 can open its page scan window 414 and begin its page scan at the appointed time and/or channel. The host device 404 can then transmit its pages 416, which will be aligned with the page scan initiated by the accessory device 402. A baseband connection 418 can then be established between the accessory device 402 and the host device 404.

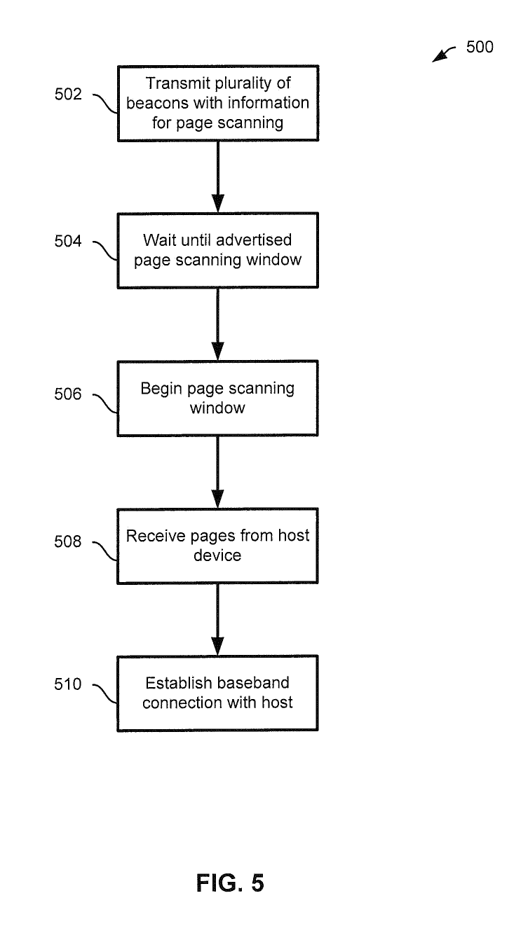

FIG. 5 is a flowchart depicting an example method 500 of establishing a connection, such as a baseband connection between a host device, e.g., host device 102, and an accessory device, e.g., accessory device 104. For convenience, FIG. 5 will be described with reference to FIGS. 1-4, but method 500 should not be understood to be limited to the specific embodiments depicted those figures.

As shown in FIG. 5, method 500 begins at 502 by an accessory device (e.g., accessory device 104) transmitting a plurality of beacons with information relating to a page scan that will occur during a future page scanning window. The beacons can include information pertaining to a page scan window (e.g., page scan 308) that it will open at some point in the future. For instance, the beacons may contain information identifying the time when the accessory device will begin a page scan, which may be represented as a temporal offset from the time the page scan window will begin. Additionally or alternately, each beacon may include information identifying any/all of a duration of the page scan window, a value of a clock for the accessory device at the beginning of the page scan window, and/or information identifying a channel that will be used during the page scan beacon.

At 504, the accessory device may wait until the time representing the beginning of the page scan, as advertised by the beacons. When such time occurs, at 506, the accessory device may begin the page scan and can receive pages from a host device (e.g., host device 102) at 508. Once the accessory device receives one or more pages from the host device, a baseband connection can be established between the accessory device and the host device at 510.

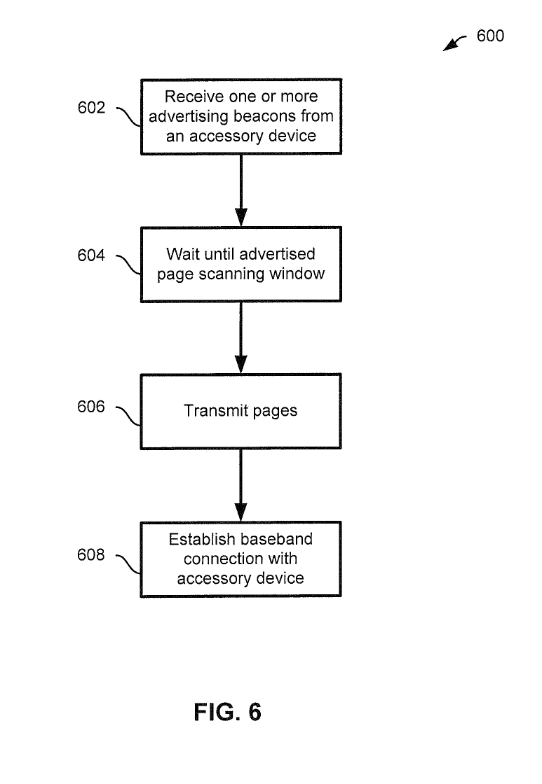

FIG. 6 is a flowchart depicting an example method 600 of establishing a connection, such as a baseband connection, between a host device, e.g., host device 102, and an accessory device, e.g., accessory device 104. For convenience, FIG. 6 will be described with reference to FIGS. 1-4, but method 600 should not be understood to be limited to the specific embodiments depicted those figures.

Method 600 begins at 602 when a host device receives one or more beacons transmitted by an accessory device. The beacons 302 may contain information identifying a time when the accessory device will begin a page scan, which may be represented as a temporal offset from the time the page scan window will begin. As noted above, a different time reference also can be used to identify the start of the page scan window, such as an absolute time reference. Furthermore, or alternately, one or more of the beacons may include information identifying any/all of a duration of the page scan window, a value of a clock for the accessory device at the beginning of the page scan window, and/or information identifying a channel that will be used during the page scan beacon.

At 604, the host device 102 waits until that advertised page scan will occur and then begins transmitting pages at 606. The connection between the host device and the accessory device can be established at 608, based on one or more received pages.

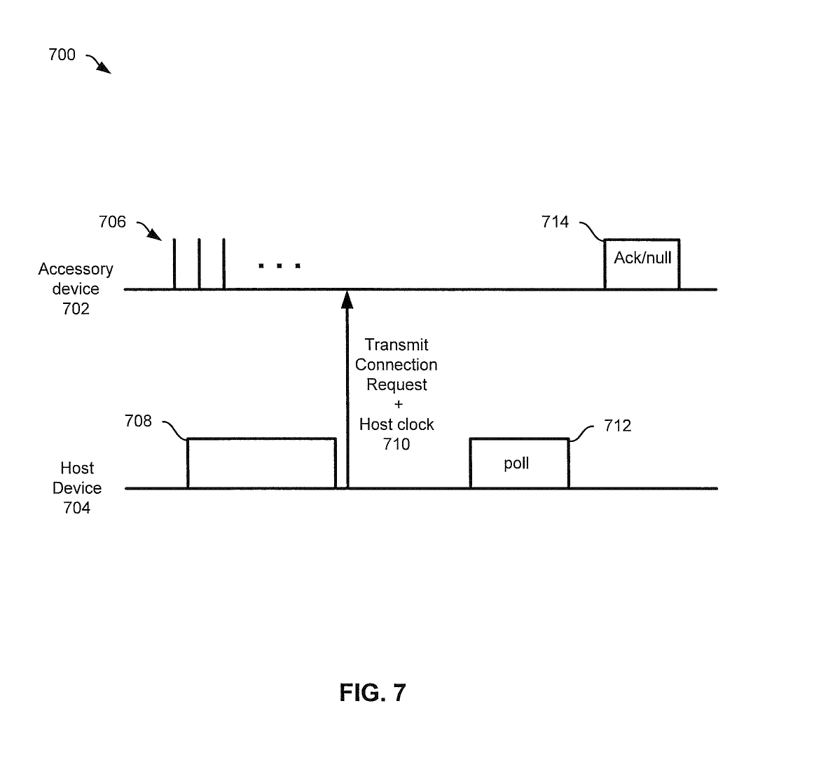

Another way to potentially reduce latency when initiating a connection between a host device (e.g., host device 102) and an accessory device (e.g., accessory device 104) according to some embodiments is for the host device to provide certain information to the accessory device prior to the initiation of the connection. Such an approach is shown in FIG. 7.

FIG. 7 is a diagram 700 depicting example signals transmitted by an accessory device 702 and a host device 704 over time, according to some embodiments. As can be seen in FIG. 7, the accessory device 702 transmits a number of beacons 706. In some embodiments, the beacons 706 may be implemented as standard Bluetooth LE beacons. In other embodiments, the beacons 706 may also or alternately be implemented as the modified beacons described above (e.g., beacons 302). The host device 704 can detect the beacons 706 during a beacon scan window 708. When the host device 704 detects the beacons 706, it can determine that the accessory device 702 is in close physical proximity to the host device 704. In some embodiments, the accessory device 702 may assume that it is in close physical proximity to the host device 704 by virtue of its having detected beacons 706. However, in addition or alternately, the host device 704 may determine that the accessory deice 702 is in close physical proximity to the host device 704 after analyzing a characteristic of the beacons 706, such as one or more of signal strength, a signal-to-noise ratio, a bit error rate, etc. In such a case, the host device 704 may conclude that it is in close physical proximity to the accessory device if one or more characteristics of the beacons 706 is above and/or below a corresponding pre-determined threshold for that characteristic. If the host device 704 would like to connect with the accessory device 702, it can transmit a connection request 710 that includes a value of the host clock. The accessory device 702 can then use the host device clock to synchronize its local clock with the host clock and a wireless connection can then be established between the accessory device 702 and the host device 704. In some embodiments, the host device may poll 712 the accessory device 702, which can acknowledge 714 with a message such as a null message.

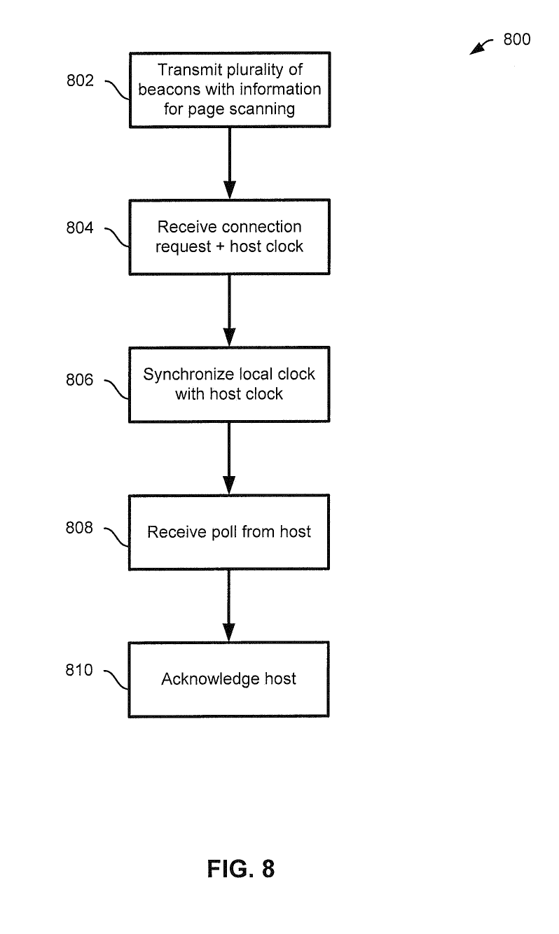

FIG. 8 is a flowchart depicting an example method 800 of establishing a wireless connection between a host device, e.g., host device 102, and an accessory device, e.g., accessory device 104, according to some embodiments. For convenience, FIG. 8 will be described with reference to FIGS. 1-7, but method 800 should not be understood to be limited to the specific embodiments depicted those figures.

Method 800 begins at 802 with transmission of a plurality of beacons (e.g., beacons 706) by an accessory device. In some embodiments, the beacons may include standard Bluetooth LE beacons, but they may also or alternately be implemented as the modified beacons described above (e.g., beacons 302). In response to the beacons, at 804, the accessory device may receive a connection request (e.g., connection request 710) from a host device. The connection request may also include a value of the host clock, e.g., for synchronization purposes. At 806, the accessory device 102 may synchronize its local clock with the host clock received in the connection request. A connection can then be established between the host device and the accessory device. At 808, a poll (e.g., poll 712) can be received from the host device and at 810, the accessory device can acknowledge the poll (e.g., acknowledgement 714.)

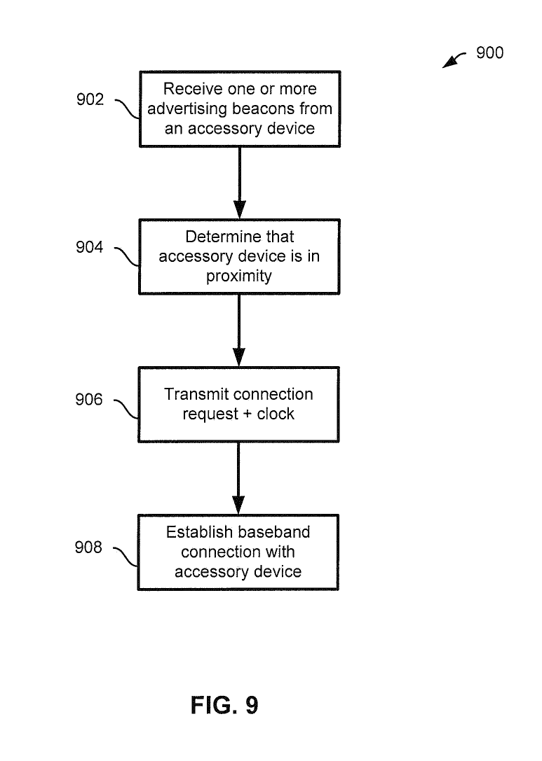

FIG. 9 is a flowchart depicting an example method 900 of establishing a wireless connection between a host device, e.g., a host device 102, and an accessory device, e.g., accessory device 104 according to some embodiments. For convenience, FIG. 9 will be described with reference to FIGS. 1-7, but method 900 should not be understood to be limited to the specific embodiments depicted those figures.

As shown in FIG. 9, method 900 begins at 902 when a host device receives one or more advertising beacons (e.g., beacons 706) from an accessory device. In some embodiments, the beacons may be implemented as standard Bluetooth LE beacons, but the beacons alternatively may be implemented as the modified beacons described above (e.g., beacons 302). The received beacons allow the host device to determine that the accessory device is in close physical proximity to the host device at 904. In response to determining that the devices are in close proximity, the host device transmits a connection request (e.g., connection request 710) to the accessory device at 906. According to some embodiments, the connection request may include information relating to a value of the host clock. At 908, a baseband connection can be established between the host device and the accessory device.

Various embodiments can be implemented, for example, using one or more well-known computer systems. For instance, each of the components and/or operations described with reference to FIGS. 1-9 could be implemented using one or more computer systems or portions thereof. A computer system can be any computer capable of performing the functions described herein.

The computer system includes one or more processors (also called central processing units, or CPUs), such as a processor. The processor is connected to a communication infrastructure or bus.

One or more processors may each be a graphics processing unit (GPU). In some embodiments, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computer system also includes user input/output device(s), such as monitors, keyboards, pointing devices, etc., that communicate with the communication infrastructure through user input/output interface(s).

The computer system also includes a main or primary memory, such as random access memory (RAM). The main memory may include one or more levels of cache. The main memory has stored therein control logic (i.e., computer software) and/or data.

The computer system may also include one or more secondary storage devices or memory. The secondary memory may include, for example, a hard disk drive and/or a removable storage device or a drive. Removable storage drive may be a floppy disk drive, a magnetic tape drive, a compact disk drive, an optical storage device, tape backup device, and/or any other storage device/drive.

The removable storage drive may interact with a removable storage unit. The removable storage unit includes a computer usable or readable storage device having stored thereon computer software (control logic) and/or data. The removable storage unit may be a floppy disk, magnetic tape, compact disk, DVD, optical storage disk, and/any other computer data storage device. The removable storage drive reads from and/or writes to the removable storage unit.

According to some embodiments, the secondary memory may include other means, instrumentalities or other approaches for allowing computer programs and/or other instructions and/or data to be accessed by the computer system. Such means, instrumentalities or other approaches may include, for example, a removable storage unit and an interface. Examples of the removable storage unit and the interface may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system may further include a communication or network interface. The communication interface enables the computer system to communicate and interact with any combination of remote devices, remote networks, remote entities, etc. For example, the communication interface may allow the computer system to communicate with remote devices over a communications path, which may be wired and/or wireless, and which may include any combination of LANs, WANs, the Internet, etc. Control logic and/or data may be transmitted to and from the computer system via the communication path.

In some embodiments, a tangible apparatus or article of manufacture including a tangible computer useable or readable medium having control logic (software) stored thereon is also referred to herein as a “computer program product” or “program storage device.” This includes, but is not limited to, the computer system, the main memory, the secondary memory, and the removable storage units, as well as tangible articles of manufacture embodying any combination of the foregoing. Such control logic, when executed by one or more data processing devices (such as the computer system), causes such data processing devices to operate as described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A method of wirelessly connecting an accessory device to a host device, comprising:
transmitting a plurality of advertising beacons over a wireless medium, wherein at least one of the advertising beacons comprises information identifying a time at which the accessory device will initiate a page scan;
initiating the page scan at the identified time;
receiving a page from a host device during the page scan; and
establishing a connection with the host device in response to the received page.

2. The method of claim 1, wherein the at least one of the advertising beacons includes information identifying a duration of the page scan.

3. The method of claim 1, wherein the at least one of the advertising beacons includes information identifying a value of an accessory device clock at the beginning of the page scan.

4. The method of claim 1, wherein the at least one of the advertising beacons includes information identifying a channel to be used during the page scan.

5. The method of claim 1, wherein:
the information identifying the time at which the accessory device will initiate the page scan comprises a temporal offset between a time the advertising beacon is transmitted and a time the page scan will be initiated.

6. The method of claim 1, wherein transmitting the plurality of advertising beacons further comprises transmitting the plurality of advertising beacons during an advertising window prior to the page scan.

7. The method of claim 1, wherein each of the plurality of advertising beacons comprises a Bluetooth low energy beacon.

8. The method of claim 1, wherein transmitting the plurality of advertising beacons further comprises transmitting the plurality of advertising beacons at regular intervals.

9. The method of claim 8, further comprising:
dynamically updating information included in at least one of the advertising beacons of the plurality of advertising beacons.

10. The method of claim 1, wherein the page scan is initiated such that it at least partially overlaps in time with the transmission of one or more of the plurality of advertising beacons.

11. A method of wirelessly establishing a connection between a host device and an accessory device, comprising:
receiving an advertising beacon from an accessory device over a wireless interface, wherein the advertising beacon comprises information identifying a time when the accessory device will begin a page scan;
generating, in response to the advertising beacon, a page;
transmitting the page after the time when the accessory device will begin the page scan; and
establishing a connection with the accessory device through the wireless interface.

12. The method of claim 11, further comprising:
determining, based at least in part on the received advertising beacon, that the accessory device is within proximity of the host device.

13. The method of claim 11, wherein the information identifying a time when the accessory device will begin a page scan window comprises a temporal offset until the page scan window will begin.

14. The method of claim 11, wherein the advertising beacon includes information identifying a duration of a page scan window corresponding to the page scan.

15. The method of claim 11, wherein the advertising beacon includes information identifying a value of an accessory device clock at the beginning of the page scan window.

16. The method of claim 11, wherein the advertising beacon includes information identifying a channel the accessory device will use during the page scan.

17. The method of claim 11, wherein the advertising beacon includes information identifying a value of a clock for the accessory device at the beginning of the page scan window.

18. The method of claim 11, further comprising:
receiving a second beacon that comprises information identifying a time when the accessory device will begin the page scan.

19. The method of claim 18, wherein the information of the advertising beacon identifying a time when the accessory device will begin the page scan and the information of the second beacon identifying a time when the accessory device will begin a page scan is differentially encoded, but identifies the same time when the accessory device will begin the page scan.

20. A method of initiating a connection between a host device and an accessory device, comprising:
determining, based at least in part on one or more beacons transmitted by the accessory device, that the accessory device is proximate to the host device;
transmitting, by the host device, a connection request to the accessory device, the connection request comprising information identifying a value of a host clock;
receiving an acknowledgement from the accessory device; and
connecting with the accessory device to form an ad hoc wireless network.
